(19) United States
(12) Patent Application Publication
(10) Pub. No.: US 2008/0220878 A1
(43) Pub. Date: Sep. 11, 2008

(54) Method and Apparatus to Create or Join Gaming Sessions Based on Proximity

(76) Inventor: Oliver Michaelis, San Diego, CA (US)

Correspondence Address: QUALCOMM INCORPORATED, 5775 MOREHOUSE DR., SAN DIEGO, CA, 92121, US

(21) Appl. No.: 12/036,149

(22) Filed: Feb. 22, 2008

Related U.S. Application Data
(60) Provisional application No. 60/891,229, filed on Feb. 23, 2007.

(51) Int. Cl. G06F 17/00

(52) U.S. Cl. 463/42; 463/43

(57) ABSTRACT

Devices and methods use a close range communication link, such as a near field communication (NFC) protocol link, to enable users to establish multiplayer gaming sessions conducted over a second communication link different from the close range link. Once two or more gaming devices are brought close enough together to establish a close range peer-to-peer communications link, the devices exchange gaming information that allows the devices to synchronize or otherwise initiate or join the game session. The devices may also exchange communication information useful for establishing the second communications link or for further game synchronization. Embodiments enable users to initiate or join multiplayer gaming sessions merely by bringing two or more game devices into close proximity.

### RELATED APPLICATIONS

The present application claims the benefit of priority to U.S. Provisional Patent Application No. 60/891,229 filed Feb. 23, 2007 entitled “Method and Apparatus to Create or Join Gaming Sessions Based on Proximity,” the entire contents of which are hereby incorporated by reference.

### FIELD OF THE INVENTION

The present invention relates generally to computer network communications, and more specifically to methods for enabling gaming sessions based on proximity.

### BACKGROUND

Video games are a popular entertainment activity that players can engage in through the use of a dedicated video game console or a personal computer. Game consoles and personal computers can be used to receive input from an attached game pad, keyboard, joystick or other game controller, process video game software, and display video game images on a connected television or monitor. Video game consoles and personal computers also can be used for multi-player games. Multi-player games typically require each player to use different game controllers attached to the same game console or computer. Multiplayer game systems can also be implemented using game consoles or computers that send data to each other over a network or other connection.

Interactive multiplayer gaming sessions across multiple game consoles or computers had previously been relegated to advanced computer users, for reasons including the complexity of establishing a communications link between the multiple game consoles or computers. Recently there has been an abundance of Internet-enabled multiplayer games available for personal computers and gaming consoles, which has lead to demand for multiplayer gaming sessions among gamers without advanced technical competency. These types of gaming sessions are typically established via game servers located on the Internet, meaning that the individual game consoles or computers that eventually create the multiplayer gaming session locate each other by communicating with a game server. However, this client-server model of multiplayer gaming sessions does not provide maximum flexibility to gamers.

The convergence of telecommunications and computer technology has lead to portable computers being able to connect to the Internet using wireless modems and also to cellular phones, which include games. The above-mentioned wireless networks enable multiple players to play the same game using different playing devices or game units without regard to geographic or physical location. Again, the traditional model of establishing multiplayer gaming sessions through outside game servers does not provide users maximum flexibility.

Ad-hoc multiplayer gaming sessions are sessions that allow gamers to communicate with each other without going through an outside game server. Ad-hoc multiplayer gaming sessions can be complicated to establish, thus out of the reach of gamers without advanced technical competency. A solution that creates and maintains multiplayer gaming sessions between gaming consoles, computers, cellular phones, or other electronic devices based on proximity would enable more users to experience multiplayer games.

### SUMMARY

A method for establishing a multiplayer game session is disclosed. The method includes establishing a close range communications link and transmitting game setup information across the close range communications link. A device configures the game session using the game setup information. The game setup information may include a starting level, advertising, player levels and device capabilities. A second communication link, different from the close range communication link, is used for playing the multiplayer game. The game application itself may also be sent across the close range communication link. Once the game setup information has been exchanged, the close range communication link may be ended and game play can proceed using the second communication link.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a system block diagram of a wireless network which includes short-range wireless communication implemented on a number of mobile devices.

FIG. 2 is a message flow diagram of an embodiment for establishing a multiplayer gaming session.

FIG. 3 is a process flow diagram of an embodiment method suitable for establishing a multiplayer gaming session.

FIG. 4 is a message flow diagram of an embodiment for establishing a multiplayer gaming session.

FIG. 5 is a process flow diagram of an embodiment method suitable for establishing a multiplayer gaming session.

FIG. 6 is a message flow diagram of an embodiment for synchronizing a multiplayer gaming session.

FIG. 7 is a process flow diagram of an embodiment method suitable for synchronizing a multiplayer gaming session.

FIG. 8 is a circuit block diagram of an example mobile device suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

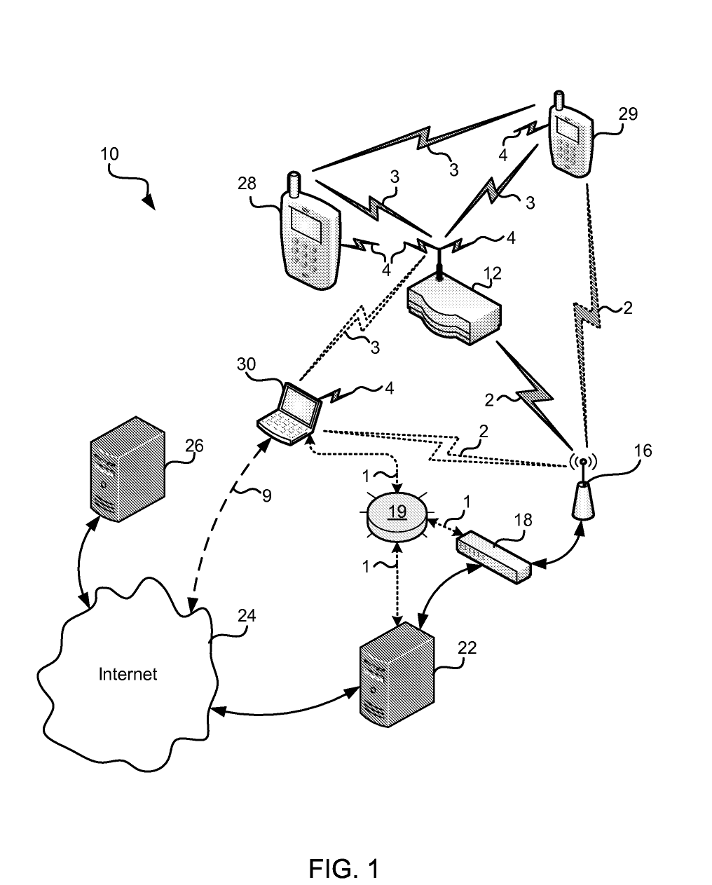

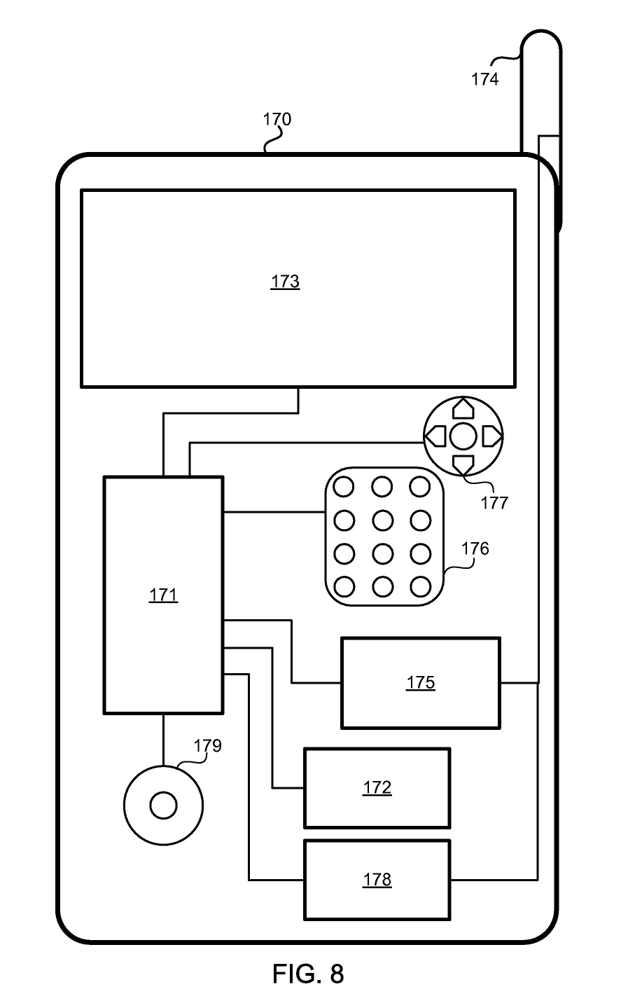

As used herein, the terms “mobile device” and “handheld device” refer to any one or all of wireless gaming controllers, cellular telephones, personal data assistants (PDA's), palm-top computers, wireless electronic mail receivers and cellular telephone receivers (e.g., the Blackberry® and Treo® devices), multimedia Internet enabled cellular telephones (e.g., the iPhone®), and similar personal electronic devices which include a programmable processor and memory, a close range communication transceiver and another communication transceiver capable of connecting to a wired or wireless network. As used herein, the terms “device,” “communication device,” “wireless device,” and “wireless communications device,” are used interchangeably to refer to electronic devices which include a close range communication transceiver, a second transceiver (which may be wired or wireless) and a processor coupled to the two transceivers which is configured with software instructions to participate in the embodiment systems and perform some steps of the embodiment methods. Some examples of suitable devices are described in more detail below with reference to FIGS. 1 and 8, but the terms are intended to be interpreted broadly as the embodiments are applicable to a broad range of applications and implementations beyond those of the example embodiments. Some embodiments refer to cellular telephone network systems including cell towers of such networks; however, the scope of the present invention and the claims encompass any wired or wireless communication system, including for example, Ethernet, WiFi, WiMax, and other wireless data network communication technologies.

The various embodiments make use of wireless proximity-limited communication technologies to exchange gaming information between devices. A variety of wireless proximity-limited communication technologies may be used for this purpose. For example, near-field communications (NFC) protocol technologies may be used. NFC protocol technology devices operate in the unregulated RF band of 13.56 MHz and fully comply with existing contactless smart-card technologies, standards, and protocols such as FeliCa and Mifare. NFC-enabled devices are interoperable with contactless smart-cards and smart-card readers conforming to these protocols. The effective range of NFC protocol communications is approximately 0-20 cm (up to 8 in.) and data communications terminates either by a command from an application using the link or when the communicating devices move out of range.

Evolving from a combination of contactless, identification and networking technologies, the NFC protocols are short-range wireless connectivity standards. A number of international standards have been established for NFC protocols, including for example: ISO/IEC 14443; ISO/IEC 15693; ISO/IEC 18092; ISO/IEC 21481; ISO/IEC 22536; ISO/IEC 23917; ISO/IEC DIS 28361; ECMA-340, referred to as NFCIP-1; ECMA-352, referred to as NFCIP-2; ECMA-356; ECMA-362; ECMA-373; ECMA/TC32-TG19/2006/057; NFC-WI; and NFC-FEC.

However, the embodiments and the claims are not necessarily limited to any one or all of the NFC protocols, and instead may encompass any close range (i.e., proximity-limited) wireless communication link. Any wireless proximity-limited communication technology may be used in some of the embodiments. In addition to the NFC protocols listed above, wireless proximity-limited communication links may be established using other close range communication media, including for example radiofrequency identification (RFID) tags and the IrDA (Infrared Data Association) protocol. Also, other close range wireless protocols and standards may be developed and may be used in the various embodiments in the same manner as NFC protocol devices. Further, longer range wireless technologies and protocols may be used with modifications or additions that limit their effective range for purposes of identifying electronic devices one to another. For example, WiFi, Bluetooth® (which communicates using the 2.4 GHz frequency band), UWB (Ultra Wideband), IEEE 802.15.4, and Zigbee® wireless communication protocols and standards may also be used in combination with range-limiting features. For example, the power of transmitters may be limited for authentication communications, such that two devices must be relatively close together (e.g., within a few feet of each other) in order to send and receive the communications. As another example, round-trip communication delay limits may be imposed such that authentication communications can only occur if the round trip of such signals is less than a threshold set to reject signals sent from more than a dozen feet or so, which maybe a short as two to three feet separation.

For simplicity of reference, the various embodiments and the claims refer to “close range communications” and “near field communications” in order to encompass any and all wireless proximity-limited communication technologies. References herein to “close range communication links” (CRCL) and “near field communications” are not intended to limit the scope of the description or the claims in any way other than the communications technology will not exchange game setup information beyond about three meters (about twelve feet). In a preferred embodiment, the communication range is limited to less than about one meter (about three feet), in a further preferred embodiment, the communication range is limited to less than about one foot, and in some embodiments the communication range is limited to is approximately 0-20 cm (up to 8 in.). In order to reflect this distinction, descriptions of embodiments using links with communication ranges of is approximately 0-20 cm (up to 8 in.) refer to “NFC protocol” links. Therefore, references to “near field communication protocol” and “NFC protocol” communications are intended to be limited to communications transceivers and technologies with ranges provided by the various NFC protocols and standards listed above, but may also include RFID transceivers and technologies with a similarly limited communication range.

With close range communications technologies, like the NFC protocol, it is possible to connect any two devices to each other to exchange information or access content and services—easily and securely. Solution vendors argue that the intuitive operation of NFC protocol systems makes the technology particularly easy for consumers to use (“just touch and go”), while the inherent security resulting from its very short communication range makes such systems ideal for mobile payment and financial transaction applications. Familiar applications of NFC protocol technology are electronic pass keys used in building security systems, mass transit fare card systems, and smart credit cards which can be brought close to a point of sale reader to complete a transaction.

As mobile devices and consumer electronic devices become more suited for multiplayer gaming, users will desire simple ways to establish multiplayer gaming sessions. Establishing multiplayer gaming sessions is typically managed by a third-party device, such as a gaming server or gaming computer. While it is possible to establish ad-hoc multiplayer gaming sessions between mobile devices, users may need to manually configure the connection, including defining how the devices can communicate with each other. Devices in a multiplayer gaming session typically will communicate with each other to exchange gaming information. This gaming information can be used to synchronize the state of the game across the devices. Typically, multiplayer games that exist across multiple devices typically rely on some level of synchronization between the devices.

In overview, the various embodiments leverage close range communications to establish multiplayer gaming sessions. The use of close range communication technology establishes physical awareness between devices that can form a multiplayer gaming session (e.g., within about 4-8 inches with NFC protocol devices). NFC protocol technologies are limited to such short ranges that users must touch or nearly touch two devices together to establish the communication link. This physical action is referred to herein as a “proximity event.” Upon such a proximity event, one of the two devices uses a close range wireless protocol to send gaming information to the other device. Thus, the proximity event and the associated wireless data communications provides an intuitive mechanism for establishing a peer-to-peer (P2P) wireless communication link; if users want to establish a new multiplayer gaming session or add a new player to an established game session, they merely touch the two devices together.

As part of or in addition to exchanging gaming information, the close range communication link may also be used to exchange information required to establish the second wired or wireless communication link that is used to conduct the multiplayer gaming session. For example, the two devices may exchange address and device identifier information necessary to enable immediately establishing a Bluetooth® wireless data link with no further synchronization activity or user action. As another example, the two devices may exchange Internet protocol (IP) or local area network address information to enable communication via WiFi wireless or Ethernet-based networks, including information with servers via the Internet. In this manner, the proximity event ensures that the two devices are able to communicate without requiring any further user action. Thus, the various embodiments enable users to initiate multiplayer gaming sessions merely by bringing two or more devices into close proximity.

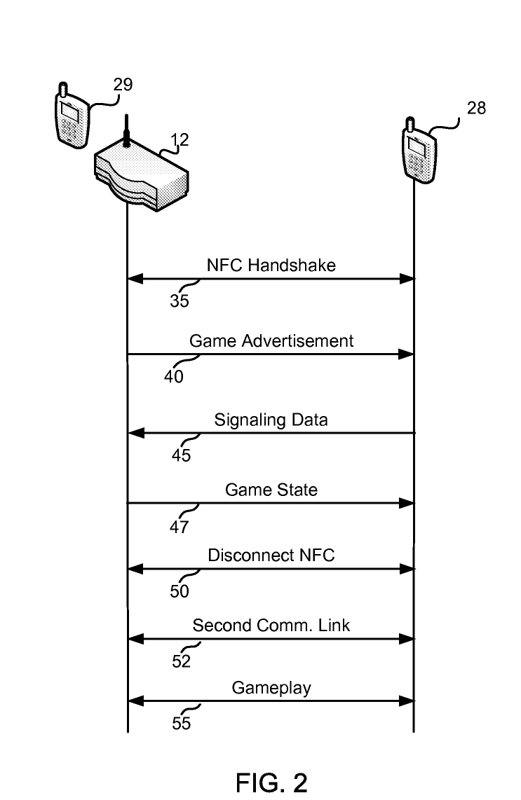

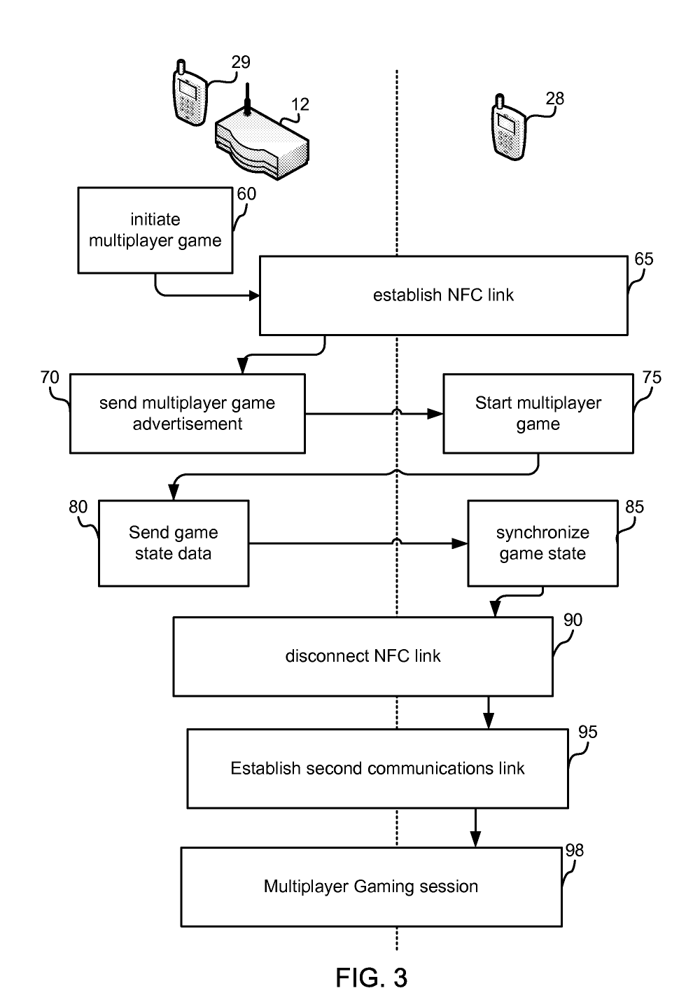

In an embodiment, a multiplayer gaming session can be established by touching two devices together and creating a close range communications link between the devices. This embodiment is explained in more detail below with reference to FIGS. 2-3.

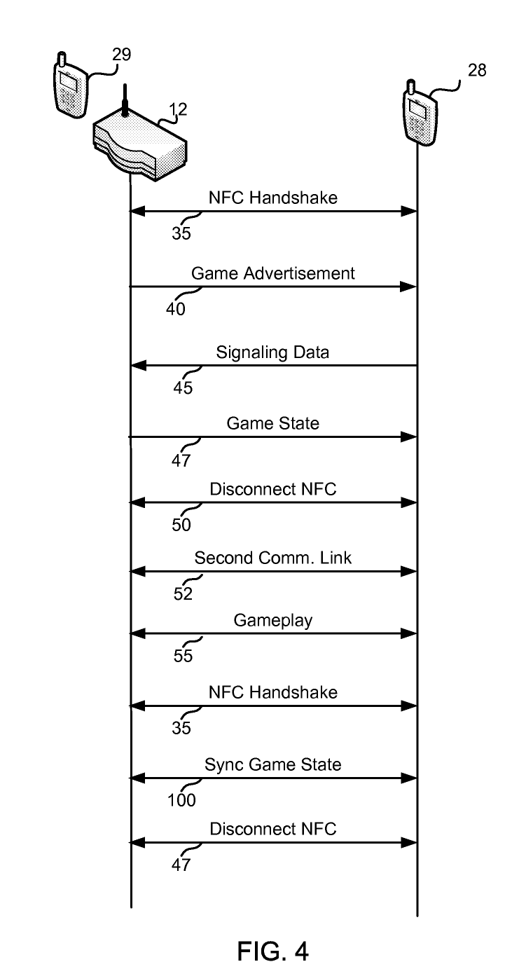

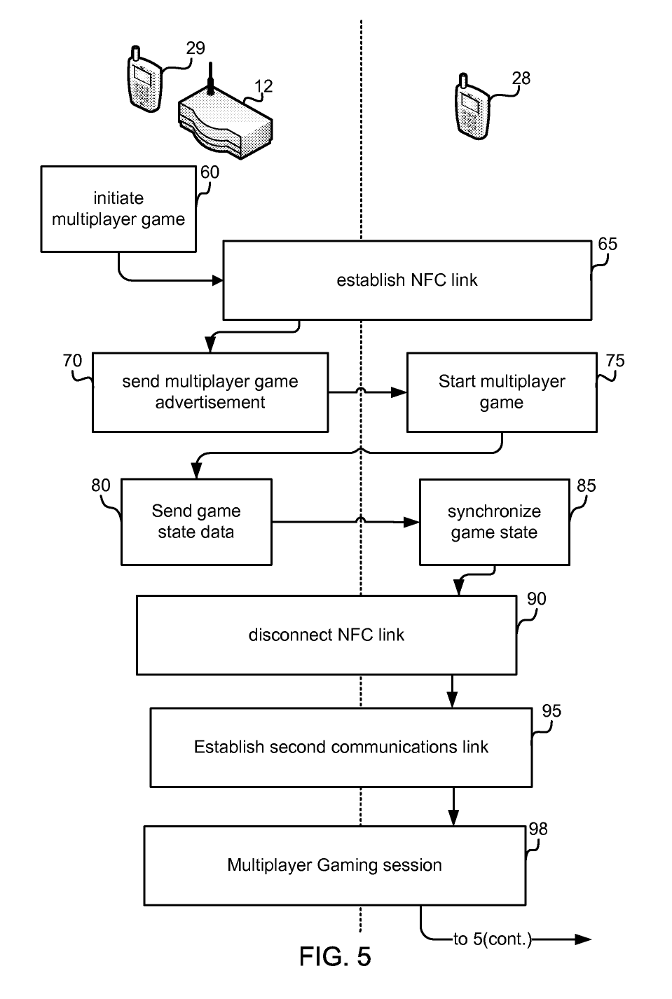

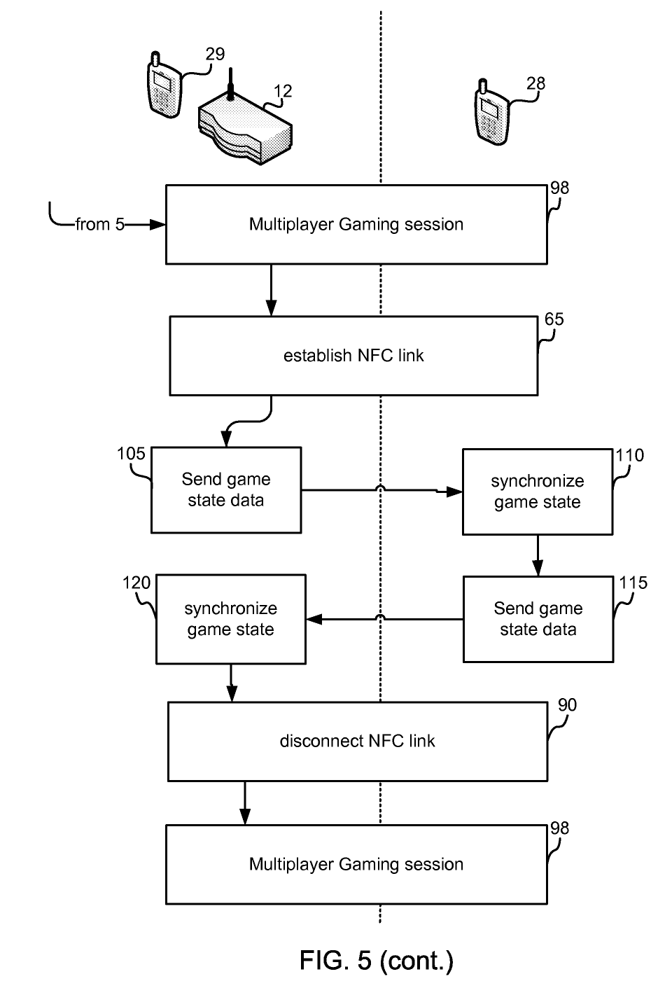

In another embodiment, a multiplayer gaming session can be established by touching the devices together on two separate occasions, once to preliminarily establish the multiplayer gaming session, and once to further synchronize the multiplayer gaming sessions. This embodiment is explained in more detail below with reference to FIGS. 4-5.

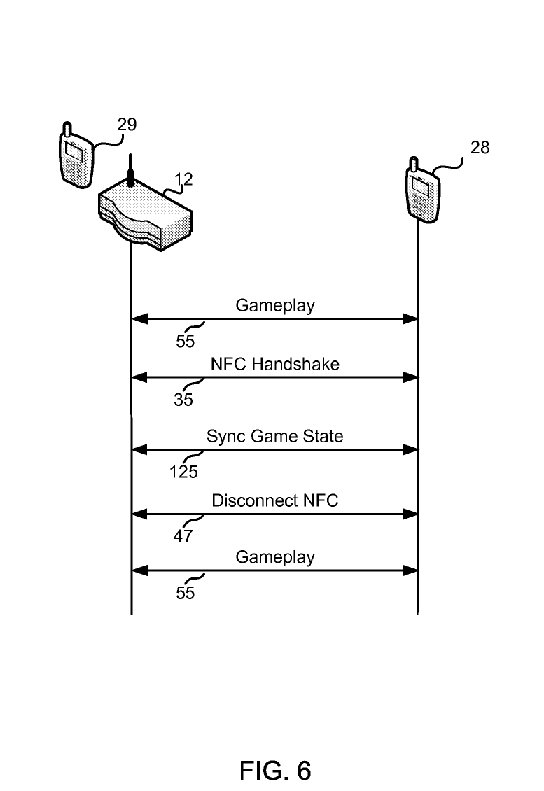

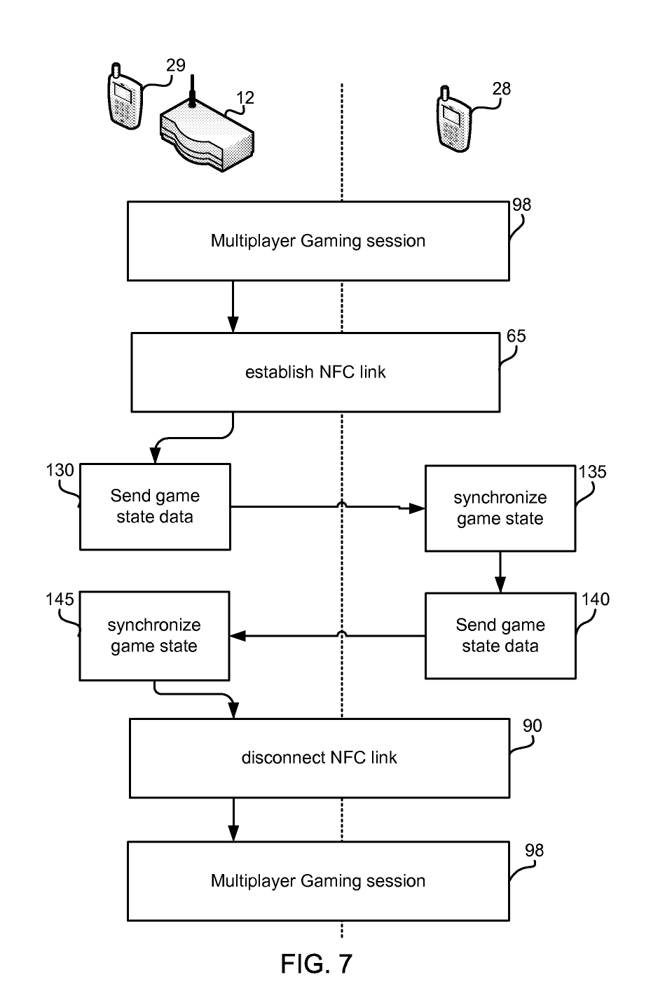

In another embodiment, a multiplayer gaming session that is already established can be further synchronized by touching the devices together. This embodiment is explained in more detail below with reference to FIGS. 6-7.

The various embodiments may be employed in a variety of wired and wireless networks, including for example a wireless network employing cellular data communication links. By way of example, FIG. 1 shows a system block diagram of a communication network 10 including a cellular network in which some mobile cellular devices have the additional ability to establish and exchange data using close-range wireless communications links, such as NFC protocol and RFID communications links. The network 10 may include a game console 12, which in the illustrated system is configured with a network antenna and transceiver for transmitting and receiving cellular signals 2 from/to a cellular base site or base station (BS) 16. The game console 12 also includes a close range communications transceiver. In this example network 10, the base station 16 is a part of a cellular network that includes elements required to operate the network, such as a mobile switching center (MSC) 18. In operation, the MSC 18 is capable of routing calls and messages to and from the game console 12 via the base station 16 when the game console 12 is making and receiving cellular data calls. The MSC 18 also provides a connection to telephone landline trunks (not shown) when the game console 12 is involved in a call. Further, the MSC 18 can, but need not, be coupled to a server gateway 22 coupled to the Internet 24.

The MSC 18 can also be coupled to a network 19 by a wired network connection 1, such as a local area network (LAN), a metropolitan area network (MAN), and/or a wide area network (WAN). The MSC 18 can be coupled to the network 19 directly by a wired network connection 1, or if the system includes a gateway 22 (as shown), the MSC 18 can be coupled to the network 19 via the gateway 22 which has a wired network connection 1 to the network 19. In a typical embodiment, the MSC 18 is coupled to the gateway 22, and the gateway 22 is coupled to the Internet 24. In turn, electronic devices such as a laptop computer 30 (as shown) or any other processing elements (e.g., personal computers, server computers or the like) can be coupled to the game console 12 via the Internet 24 by way of their own Internet connection 9. In a further embodiment, one or more processing elements associated with a game server 26 may be coupled to this network 10 by way of the Internet 24.

In addition to cellular network communications 2, the game console 12 may be equipped to communicate with other devices, such as mobile devices 28, 29, 30 via a local wireless network 3 and a close-range communication link 4. For example, in the FIG. 1 embodiment, the game console 12 is configured to communicate with a first mobile device 28, a second mobile device 29 and a laptop computer 30, each equipped with an internal close range communications transceiver (e.g., for example an NFCIP-2 transceiver). The game console 12 is also configured to communicate with these devices 28, 29, 30 via another longer range wireless communication link, such as a WiFi, Bluetooth® or other local area wireless link 3. For example, the game console 12 may include an NFCIP-2 NFC transceiver and an IEEE 802.11g (WiFi) wireless data network transceiver. Similarly, the mobile devices 28, 29 and the laptop computer 30 are illustrated as configured with compatible NFC protocol and local area (or wide area) wireless transceivers. While FIG. 1 shows a game console 12 to be an immobile terminal, this device may itself be a mobile device, such as a cellular telephone, laptop computer or personal computer on a mobile cart.

The close range communication transceivers in the game console 12 and the other network devices 28, 29, 30 may be any of a number of different known transceivers (including for example RFID tags) capable of transmitting and/or receiving data in accordance with any of a number of different close range techniques, such as defined in the NFC protocols and standards listed above. For example, the close range communications transceiver may be a NFCIP-1 or NFCIP-2 transceiver, an RFID transceiver or RFID tag, or use Bluetooth® (i.e., communication in the 2.4 GHz frequency band), infrared, IrDA (Infrared Data Association), UWB (Ultra Wideband) or other wireless communication link.

The game console 12 and network devices 28, 29, 30 also include a second data communication link used for transmitting game play data within the multiplayer gaming session. For example, as illustrated in FIG. 1, the second data communication link may be a local area wireless link 3, such as according to the IEEE 802.11g standard. This second data communication link need not be wireless, and can be a wired local area network (not shown), such as a ring token network or an Ethernet network.

In addition to mobile devices 28, 29 and laptop computers 30, the network 10 may also or alternatively include any of a number of different electronic devices, including other mobile terminals, wireless accessories (e.g., mass storage devices, networked printers, monitors, etc.), portable digital assistants (PDAs), pagers, desk top computers, data sensors, and other types of electronic systems.

FIG. 1 illustrates devices that may be members of a multiplayer gaming session. For example, a multiplayer gaming session may be established among the game console 12, mobile devices 28, 29 and a laptop computer 30. An example of a multiplayer gaming session may be established around a game console 12 that is a stand alone gaming computer, such as a personal computer configured with game software or a dedicated video game console, that executes the game software and serves as a communication hub for a plurality of gaming controllers and/or mobile devices 28, 29 used by players. As another example, a multiplayer gaming session may be established around a networked computer system that uses the game console 12 as a hub for wirelessly extending the multiplayer gaming session to mobile devices 28, 29. In such examples, the multiplayer gaming session is able to share game play data within the devices via messages transmitted by a wireless data link 3 that is different from the close range communication link 4. Such multiplayer gaming session transmissions may be peer-to-peer links, such as illustrated between mobile device 28 and mobile device 29, or indirect network communications via the game console 12, such as illustrated between the mobile devices 28, 29 and the laptop computer 30. Such a multiplayer gaming session may also communicate with external websites and data sources, such as by the game console 12 communicating via a cellular data communication link 2 with a base station 16 coupled to the Internet 24, or the laptop computer 30 connected directly to the Internet 24 as illustrated. Similarly, one or more of the mobile devices 28, 29 may also be able to communicate directly with the base station 16, such as by a cellular data communication link 2.

The architecture illustrated in FIG. 1 also supports multiplayer gaming sessions that include distant elements, such as a server 26 coupled to the Internet 24. For example, a multiplayer gaming session may be administered by a game server 26 via the Internet 24. Messages intended for the multiplayer gaming session may be transmitted from the game server 26 via the Internet 24 to a base station 16 and then to the game console 12 as illustrated. From game console 12, the multiplayer gaming session messages may be rebroadcast via local wireless communication links 3 to the other group members 28, 29, 30. Messages from any member of the multiplayer gaming session may then be routed to the game server 26 in a reverse manner. Similarly, the multiplayer gaming session may include computing devices that are beyond the range of the game console 12, such as a computer coupled to the Internet 24. Messages to and among multiplayer gaming session members may be directed to each member device using IP addresses using addressing schemes that are well known in the Internet arts.

While the protocols and methods for communicating to, from and within a multiplayer gaming session are well known, the various embodiments provide new mechanisms for establishing multiplayer gaming sessions or for joining new members to an existing multiplayer gaming session. By adding close range communication transceivers to the game console 12 and player mobile devices 28, 29, 30, the proximity limitation of such transceivers is leveraged to make two unrelated devices, such as the game console 12 and a mobile device 28, aware of each other. Thus, to add a first mobile device 28 to a multiplayer gaming session including the game console 12, the first mobile device is brought into very close proximity with the game console 12. Using one of the known close range communication techniques (e.g., the NFC protocol), the first mobile device 28 and the game console 12 establish a close range communications link 4 and exchange a multiplayer game advertisement over the close range communications link 4. As part of exchanging a multiplayer game advertisement, the address of the first mobile device 28 may be provided to the game console 12 for use by the multiplayer gaming session, and the multiplayer gaming session address and/or game state information are communicated from the game console 12 to the first mobile device 28. Additional information such as user notification and/or multiplayer gaming session participation confirmation may also be exchanged at this point.

In an embodiment the first mobile device 28 and the game console 12 have data connectivity via disparate physical links, e.g. an 802.11g wireless link 3 or a CDMA cellular data communication link 2 in addition to the close range link 4. In this embodiment, the multiplayer gaming session can be established using the 802.11g wireless link 3, the CDMA cellular data communication link 2, or both. In a further embodiment, one or more of the group devices (e.g., the laptop computer 30) may include a wired network link 1 that can be used for multiplayer gaming session communications.

The network 10 illustrated in FIG. 1 enables a variety of connections between mobile devices 28, 29 and other computing devices on the network, such as a laptop 30. For example, the multiplayer gaming session can communicate by means of cellular communications networks 2, by local wireless networks 3, by wired network connections 1 accessed via cellular communication links 2 to the base station 16 via the MSC 18 and network 19, and via the Internet 24 by an Internet connection 9. This flexibility in network connections is illustrated with respect to the laptop 30 with dashed communications symbols. Once a multiplayer gaming session has been established or joined by the short range communication link 4 procedures described herein, the multiplayer gaming session devices may communicate with each other directly through peer-to-peer links or indirectly via networks 1, 2, 3, 9, or 24.

While FIG. 1 is described above as being based upon a cellular data network, the same basic architecture may be implemented with other wireless network technologies, such as a WiFi or WiMax network. In such alternative wireless technologies, the base station 16 would be a WiFi or WiMax (for example) base station. Other elements of such a network 10 would be substantially the same as shown in FIG. 1 and described above, except that the game console 12 and other network elements 28, 29, 30 would be configured to communicate using the WiFi (or other) wireless communication protocol. Accordingly, a separate figure for depicting alternative wireless and wired communication technology networks is unnecessary, and references to components in subsequent figures using reference numerals shown in FIG. 1 are intended to encompass both cellular and other wired and wireless network elements. Similarly, the game console 12 may be coupled to a local area network 19 by a wired connection (similar to the wired network connection 1 shown in coupling to the laptop 30), and need not include a cellular network transceiver.

In a first embodiment illustrated in FIGS. 2 and 3, a multiplayer gaming session is established by touching two devices together. An overview of basic communications that may occur between devices establishing a multiplayer gaming session in the various embodiment methods is illustrated in FIG. 2. In this example, the multiplayer gaming session may be established between a first gaming device 28 and either a second gaming device 29 or a game console 12. For simplicity, the examples will refer only to the second gaming device 29, but it should be recognized that embodiments encompass establishing a multiplayer gaming session between the gaming device 28 and the game console 12 which will involve very similar processes. Further, references to establishing a multiplayer gaming session are intended to include and encompass both establishing a new multiplayer gaming session and establishing a link to (i.e., joining) an established multiplayer gaming session.

To establish a multiplayer gaming session, the first gaming device 28 and the second gaming device 29 may first establish a close range communication link, such as an NFC protocol link, through a series of hand-shaking messages, such as the handshaking messages defined in the NFC protocols, messages 35. The second gaming device 29 may then send a multiplayer game advertisement to the first gaming device 28 that invites the other device to play a multiplayer game, message 40. (Note that either device may send a game advertisement and signaling data, and the reference to one device versus the other in the embodiment descriptions is arbitrary and for example purposes only.) The game advertisement may include instructions on how to download the game if the first gaming device does not already have access to a copy of the game. Alternatively, the game advertisement may include executable code of the game itself.

The first gaming device 28 may accept the invitation by replying with signaling data that the devices can use to establish a second (third or more) communication link, message 45. As previously described, the second communication link is used as the backbone link for the transmission of game play data between the participating devices 28, 29 and game console 12 and/or server 26. As discussed above, such a second communication link may be CDMA, Bluetooth®, WiFi, Ethernet, or other wired or wireless communication technology. Further, the second (or third) communication link may be established between devices that cannot directly communicate with each other by using a third device as a gateway. Also, a third (or fourth) communication link may be established to transmit game play data over another media, such as the Internet, to connect all members of the multiplayer game together.

The two gaming devices 28, 29 establishing a multiplayer gaming session may also exchange game state data over the close range communications link, message 47. This initial game state information may be used by the devices 28, 29 to synchronize the multiplayer gaming session. Such synchronization may include any part of the game state that is not constant. This may include settings such as the level of the game which will be played, which computer-controlled and user-controlled characters will participate in a given level, and the user-selected strength of the artificial intelligence. The initial game state information may also include more technical details, such as the specific version of the game being played, data associated with the current actions and activities, roles (and thus controller behaviors) assigned to the new device 28, controller settings, etc.

The multiplayer gaming devices may disconnect the close range communications link, messages 50, and establish the second communications link through a series of hand-shaking communications, messages 52. The multiplayer gaming session is now established and game play can proceed with the exchange of game play data (e.g., gaming commands from the device 28 to the console 12 and feedback and video from the console 12 to the device 28) using the second communication link, messages 55.

In this embodiment, the order of the messages passed between gaming devices 28, 29 is not crucial. In an implementation, the second communications link may be established between the gaming devices 28, 29 before the close range communications link is disconnected. In another implementation, the game state data may be sent over the second communications link before or after the close range communications link is disconnected. In another implementation, the second communication link is established before the close range communications link is established. For example, to join a game, a user activates a new mobile device 28 which establishes the second communication link with the game console 12. The game console 12 then signals the new user to touch the mobile device 28 to the game console 12 in order to join the game. Also, game play may continue via the second communication link while devices communicate via a close range communication link. Alternatively, the devices and the game software may be configured to pause the game whenever two devices establish a close range communication link, thereby providing an easy mechanism to pause a game and prevent the game from proceeding while devices are exchanging synchronization information.

An embodiment method is illustrated in FIG. 3 showing process steps that can be implemented on various gaming devices. The user of the second gaming device 29 may begin the process of establishing a multiplayer gaming system by selecting such an option on the gaming device 29, step 60. Alternatively, the gaming device 29 may be configured to automatically attempt to establish a multiplayer gaming session upon some or all proximity events. When brought close together, the first gaming device 28 and the second gaming device 29 establish a close range communications link based on proximity, step 65. The second gaming device 29 may then send a multiplayer game advertisement using the close range communications link, step 70. Such an advertisement may include information relating to the specific game the users wish to play, or it may include a list of games from which the other gaming device 28 can select. The first gaming device 28 may prepare for game play by loading the executable code into memory, step 75. Alternatively, the executable code may already be in memory (i.e., step 75 may be performed earlier). The second gaming device 29 may prepare and send data necessary to synchronize the gaming session, step 80. The first gaming device 28 receives the data and alters the state of the game instance to match the state of the second gaming device, step 85. The gaming devices disconnect the close range communications link such as by ending the proximity event (i.e., moving beyond the communication range), step 90. At some point, the gaming devices also establish a second communications link, step 95. Finally, the gaming devices enjoy a full-functioned multiplayer gaming session with game data exchanged using the second communications link, step 98. As previously discussed, the order of steps shown in FIG. 3 is arbitrary.

In a second embodiment illustrated in FIGS. 4 and 5, the multiplayer gaming session may be further synchronized during game play by initiating a second proximity event. Further synchronization through additional proximity events has various advantages, including the low latency of synchronizing data exchanges possible with NFC protocol links and the opportunities for a more interactive user experience. For example, multiplayer game users may want to begin the game-play stage of a multiplayer game at precisely the same time. They can accomplish this utilizing a two-tap method where the first tap prepares the game to be played and the second tap starts the game clock. As another example, some events or processes within the game may be initiated or synchronized by tapping game devices together.

An overview of basic communications that may occur between devices establishing a multiplayer gaming session in the various two-tap embodiment methods is illustrated in FIG. 4. This two-tap embodiment may begin similar to the one-tap embodiment described above, or be implemented as a superset of the one-tap embodiment. Accordingly, the first gaming device 28 and the second gaming device 29 may establish a close range communications link through a series of hand-shaking messages, messages 35. The second gaming device 29 may then send a multiplayer game advertisement to the first gaming device 28 that invites the device 28 to join the multiplayer game, message 40. The first gaming device may accept the invitation by replying with signaling data that the devices can use to establish a second communication link, message 45. The two gaming devices establishing a multiplayer gaming session may also exchange game state data, message 47. The multiplayer gaming devices may disconnect the close range communications link, messages 50, and establish a second communications link through a series of hand-shaking communications, messages 52. The multiplayer gaming session is now established and game play can proceed with the exchange of game play data (e.g., gaming commands from the device 28 to the game console 12 and feedback and video from the game console 12 to the device 28) using the second communications link, messages 55.

A second tap, such as to synchronize the game state, may proceed in a manner similar to the first tap. The first gaming device 28 and the second gaming device 29 establish another close range communications link through a series of hand-shaking messages, message 35. The first gaming device 28 may send synchronization data to the second gaming device 29, while the second gaming device 29 sends synchronization data back to the first gaming device 28, messages 35. The gaming devices can then disconnect the close range communications link, messages 47, to continue the game play.

A method of such two-tap multiplayer gaming embodiments is illustrated in FIG. 5. The user of the second gaming device 29 may begin the process of establishing a multiplayer gaming system by selecting such an option on the gaming device, step 60. The first gaming device 28 and the second gaming device 29 establish a close range communications link based on proximity, step 65. The second gaming device 29 then sends a multiplayer game advertisement to the other device, step 70. The first gaming device 28 may prepare for game play by loading the executable code into memory if it is not already in memory, step 75. The second gaming device 29 may prepare and send data necessary to synchronize the gaming session, step 80. The first gaming device 28 receives the data and alters its game state vector to match the state provided by the second gaming device 29, step 85. The gaming devices disconnect the close range communications link by ending the proximity event, step 90. At some point the gaming devices also establish a second communications link, step 95. The multiplayer gaming session is now established, step 98, although game play has not yet begun.

The users may begin game play by utilizing a second tap to exchange game state data or to simply inform the game that play is to begin. This is accomplished by establishing a close range communications link through a second proximity event, step 65. The second gaming device 29 may prepare and send game state data to the other device 28, step 105. The first gaming device 28 receives the game state data and uses the data to synchronize the game state, step 110. Based on the game state data it received from the second gaming device 29, the first gaming device 28 may determine what data needs to be sent to the second gaming device to complete the sync, step 115. The second gaming device 29 receives game state data from the first gaming device 28, and completes the sync, step 120. The gaming devices disconnect the close range communications link by ending the proximity event, step 90, and continue with the multiplayer gaming session, 98. The additional synchronization that occurs during the second tap may not be required, and instead the establishment or termination of the second close range communications link may be used simply as the trigger for initiating the game play. In an example of using the second tap to start a game clock, the only synchronization that may be required is the disconnection of the close range communications link due to the end of the proximity event (i.e., the players pulling their mobile devices apart).

In a third embodiment illustrated in FIGS. 6 and 7, users of multiplayer games may utilize a multitude of taps to synchronize the game state. It may be beneficial to periodically synchronizing game information over a close range communications link instead of the second communications link due to reduced latency or to enhance the user experience. For example, the event of tapping-together of the gaming devices may be used by the game to transfer objects from one gaming device to the other, or to enable two players to collaborate (e.g., the tapping equating to shaking hands). As another example, tapping a game device to a game console 12 or another device (which may or may not be another gaming device) could be used to cause the game to select or reload a weapon or restore health. As a further example, multiple tapping proximity events may be used synchronize game play and enable multiplayer gaming across gaming devices that lack a second communication capability. Gaming devices may have no additional connectivity built in, or may be required to disable it from time to time (such as when on an airplane). Some multiplayer games may not require constant synchronization, merely synchronization at the end of each level or turn.

An overview of basic communications that may occur between devices synchronizing a multiplayer gaming session using multiple-tap embodiment methods is illustrated in FIG. 6. A multiplayer gaming session has been established through one of the embodiment methods described above or another known method, and game-play is ongoing, messages 55. The first gaming device 28 and second gaming device 29 establish a close range communications connection through a series of hand shaking messages, messages 35. The first gaming device and second gaming device exchange game state information, messages 125. The first gaming device 28 and the second gaming device 29 disconnect the close range communications session, messages 47, and return to game play, messages 55.

Steps of such a method are illustrated in FIG. 7. While the first gaming device 28 and second gaming device 29 have an established multiplayer gaming session, step 98, the users initiate a proximity event and the devices establish a close range communications link, step 65. The second gaming device 29 prepares and sends game state data, step 130. The first gaming device 28 receives the game state data and uses the data to synchronize the game state, step 135. Based on the game state data it received from the second gaming device 29, the first gaming device 28 may determine the data needs to be sent to the second gaming device 29 to complete the sync, step 140. The second gaming device receives the game state data from the first gaming device 28, and completes the synchronization, step 145. The gaming devices disconnect the close range communications link when the players end the proximity event, step 90, and continue with the multiplayer gaming session, step 98.

The various embodiments may have many commercial uses beyond the realm of computer games. For example, advertising media (e.g. posters including close range communications transceivers, referred to herein as “smart posters”) may be used to trigger demo gaming sessions with additionally available game features temporarily enabled. Such smart posters may have NFC protocol technology transceivers embedded within or behind the poster that can communicate the game application to a mobile device over an NFC protocol link and enable game play via a BlueTooth® or WiFi data link broadcast from a console or server in the vicinity. For example, users attending a premier of the latest superhero movie can go up to the movie poster, swipe their mobile device over the poster to initiate an NFC protocol link to an embedded NFC transceiver, and receive a multiplayer game advertisement. Users may then play a demo multiplayer game with other users in the area.

In another example, close range communication technologies may be used by amusement parks that employ range limited transceivers in their waiting lines to allow visitors to join theme-specific games or game features. In another example, close range communication technologies may be used on public transportation to allow riders to receive location specific aspects of games or game features, such as incorporating into the game local scenes or activities that are visible out the windows. Further, close range communication technologies may be used to link real-world features into a multiplayer game, for example to create a combined reality/virtual reality treasure hunt. By using close range communications technology, location specific information may be transmitted to the mobile device when the device is presently located where the information is most relevant to the multiplayer game being conducted over a long range communication link.

The embodiments described above may be implemented on any of a variety of gaming devices, such as, for example, wireless game controllers, cellular telephones, personal data assistants (PDA) with cellular telephone, mobile electronic mail receivers, mobile web access devices, and other processor equipped devices that may be developed in the future with close range communications capabilities. Typically, such gaming device will have in common the components illustrated in FIG. 8. For example, the gaming device 170 may include a processor 171 coupled to internal memory 172 and a display 173. Additionally, the gaming device 170 will have an antenna 174 for sending and receiving electromagnetic radiation that is connected to a wireless data link and/or cellular telephone transceiver 175 coupled to the processor 171. In some implementations, the transceiver 175 and portions of the processor 171 and memory 172 used for cellular telephone communications are collectively referred to as the air interface since it provides a data interface via a wireless data link. Additionally, the gaming device 170 will include a close range communications transceiver 178 (e.g., an NFC protocol transceiver) which may be connected to the antenna 174 (or include its own antenna) that is capable of establishing and communicating over a close range communications link. For example, the transceiver 178 may be an NFC protocol transceiver supporting one or more of the near field communication protocols.

The processor 171 may be any programmable microprocessor, microcomputer or multiple processor chip or chips that can be configured by software instructions (applications) to perform a variety of functions, including the functions of the various embodiments described above. In some gaming devices, multiple processors 171 may be provided, such as one processor dedicated to wireless communication functions and one processor dedicated to running other applications, such as game applications. Typically, software applications may be stored in the internal memory 172 before they are accessed and loaded into the processor 171. In some gaming devices, the processor 171 may include internal memory sufficient to store the application software instructions. In some mobile devices, additional memory chips (e.g., a Secure Data (SD) card) may be plugged into the device and coupled to the processor. For the purposes of this description, the term memory refers to all memory accessible by the processor 171, including internal memory 172, removable memory plugged into the mobile device, and memory within the processor 171 itself. In many gaming devices, the memory 172 may be a volatile or nonvolatile memory, such as flash memory, or a mixture of both. Gaming devices typically include a key pad 176 or miniature keyboard and menu selection buttons or rocker switches 177 for receiving user inputs. Additionally, gaming devices may also include a joystick 179 or similar mechanism for receiving user inputs.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

I claim:

1. A method for creating a multiplayer gaming session among a first gaming device and a second gaming device, comprising:
establishing a close range communications link between the first gaming device and the second gaming device;
sending a multiplayer game advertisement pertaining to the multiplayer gaming session from the first gaming device to the second gaming device using the close range communications link;
sending game synchronization data from the first gaming device to the second gaming device; and
commencing the multiplayer gaming session among the first gaming device and the second gaming device using a second communications link different from the close communications link.

2. The method of claim 1, further comprising:
sending signaling data pertaining to a communications capability from the first gaming device to the second gaming device using the close range communications link; and
establishing the second communications link based on the signaling data.

3. The method of claim 1, further comprising:
sending game synchronization data from the first gaming device to the second gaming device using the close range communications link.

4. The method of claim 1, further comprising:
discontinuing the close range communications link prior to commencing the gaming session.

5. The method of claim 4, further comprising:
establishing a close range communications link between the first gaming device and the second gaming device; and
sending game state data from the first gaming device to the second gaming device using the close range communications link.

6. The method of claim 1, further comprising:
establishing a close range communications link between the first gaming device and a third gaming device;
sending a multiplayer game advertisement pertaining to the multiplayer gaming session from the first gaming device to the third gaming device using the close range communications link;
sending game synchronization data from the first gaming device to the third gaming device; and
joining the third gaming device to the multiplayer gaming session.

7. The method of claim 1, wherein the close range communications link is a near field communications (NFC) protocol link.

8. An electronic device, comprising:
a processor;
a first transceiver coupled to the processor;
a second transceiver coupled to the processor, the second transceiver being a close range communication transceiver; and
a memory coupled to the processor;
wherein the processor is configured with software instructions to perform steps comprising:
establishing a close range communications link between the gaming device and a second gaming device via the second transceiver;
sending, over the close range communications link, a multiplayer game advertisement pertaining to a multiplayer gaming session;
sending game synchronization to the second gaming device; and
commencing the multiplayer gaming session among the gaming device and the second gaming device, wherein gaming messages are sent and received over a second communications link via the first transceiver.

9. The electronic device of claim 8, wherein the processor is configured with software instructions to perform steps further comprising:
sending signaling data pertaining to a communications capability to the second gaming device using the close range communications link; and
establishing the second communications link via the first transceiver based on the signaling data.

10. The electronic device of claim 8, wherein the processor is configured with software instructions to perform steps further comprising:
sending game synchronization data from to the second gaming device using the close range communications link.

11. The electronic device of claim 8, wherein the processor is configured with software instructions to perform steps further comprising:
discontinuing the close range communications link prior to commencing the gaming session.

12. The electronic device of claim 11, wherein the processor is configured with software instructions to perform steps further comprising:
establishing a close range communications link between the gaming device and the second gaming device via the second transceiver; and
sending game state data from to the second gaming device using the close range communications link.

13. The electronic device of claim 8, wherein the processor is configured with software instructions to perform steps further comprising:
establishing a close range communications link between the first gaming device and a third gaming device;
sending a multiplayer game advertisement pertaining to the multiplayer gaming session from the first gaming device to the third gaming device using the close range communications link;
sending game synchronization data from the first gaming device to the third gaming device; and
joining the third gaming device to the multiplayer gaming session.

14. The electronic device of claim 8, wherein the second transceiver is a near field communications (NFC) protocol transceiver.

15. A tangible storage medium having stored thereon processor-executable software instructions configured to cause a processor to perform steps comprising:
establishing a close range communications link between a first gaming device and a second gaming device;
sending a multiplayer game advertisement pertaining to a multiplayer gaming session from the first gaming device to the second gaming device using the close range communications link;
sending game synchronization data from the first gaming device to the second gaming device; and
commencing the multiplayer gaming session among the first gaming device and the second gaming device using a second communications link different from the close range communications link.

16. The tangible storage medium of claim 15, wherein the tangible storage medium has processor-executable software instructions configured to cause a processor to perform further steps comprising:
sending signaling data pertaining to a communications capability from the first gaming device to the second gaming device using the close range communications link; and
establishing the second communications link based on the signaling data.

17. The tangible storage medium of claim 15, wherein the tangible storage medium has processor-executable software instructions configured to cause a processor to perform further steps comprising:
sending game synchronization data from the first gaming device to the second gaming device using the close range communications link.

18. The tangible storage medium of claim 15, wherein the tangible storage medium has processor-executable software instructions configured to cause a processor to perform further steps comprising:
discontinuing the close range communications link prior to commencing the gaming session.

19. The tangible storage medium of claim 18, wherein the tangible storage medium has processor-executable software instructions configured to cause a processor to perform further steps comprising:
establishing a close range communications link between the first gaming device and the second gaming device; and
sending game state data from the first gaming device to the second gaming device using the close range communications link.

20. The tangible storage medium of claim 15, wherein the tangible storage medium has processor-executable software instructions configured to cause a processor to perform further steps comprising:
establishing a close range communications link between the first gaming device and a third gaming device;
sending a multiplayer game advertisement pertaining to the multiplayer gaming session from the first gaming device to the third gaming device using the close range communications link;
sending game synchronization data from the first gaming device to the third gaming device; and
joining the third gaming device to the multiplayer gaming session.

21. The tangible storage medium of claim 15, wherein the close range communications link is a near field communications (NFC) protocol link.

22. An electronic device, comprising:
means for establishing a close range communications link with a second electronic device;
means for sending over the close range communications link a multiplayer game advertisement pertaining to a multiplayer gaming session;
means for sending game synchronization data to the second gaming device;
means for communicating game data via a second communications link different from the close range communications link; and
means for commencing the multiplayer gaming session with the second gaming device, wherein game data are sent and received via the second communications link.

23. The gaming device of claim 22, further comprising:
means for sending signaling data pertaining to a communications capability to the second gaming device using the close range communications link,
wherein the means for communicating game data uses the signaling data to establish the second communications.

24. The gaming device of claim 22, further comprising:
means for sending game synchronization data from to the second gaming device using the close range communications link.

25. The gaming device of claim 22, wherein the processor is configured with software instructions to perform steps further comprising:
means for discontinuing the close range communications link prior to commencing the gaming session.

26. The gaming device of claim 25, further comprising:
means for reestablishing a close range communications link with the second gaming device; and
means for sending game state data to the second gaming device using the close range communications link.

27. The gaming device of claim 22, further comprising:
means for establishing a close range communications link between with a third gaming device;
means for sending a multiplayer game advertisement pertaining to the multiplayer gaming session to the third gaming device using the close range communications link;
means for sending game synchronization data to the third gaming device; and
means for joining the third gaming device to the multiplayer gaming session.

28. The gaming device of claim 22, wherein the means for establishing a close range communications link comprises means for establishing a near field communications (NFC) protocol communication link, and the close range communication link is an NFC protocol communication link.
